(19) United States
(12) Patent Application Publication
(10) Pub. No.: US 2003/0148121 A1
(43) Pub. Date: Aug. 7, 2003

(54) Metallized film having a medium density polyethylene layer

(75) Inventors: Vittoriano DiLuzio, Morristown, TN (US); Greg Gillis, Morristown, TN (US); Paul Alder, Rawdon (CA); Michael T. Heffelfinger, Alpharetta, GA (US)

Correspondence Address: HINKLE & O'BRADOVICH, LLC, 395 SCENIC HIGHWAY, LAWERENCEVILLE, GA, 30045, US

(73) Assignee: Vifan USA, Inc.

(21) Appl. No.: 10/071,054

(22) Filed: Feb. 7, 2002

(51) Int. Cl. B32B 15/08

(52) U.S. Cl. 428/461; 428/500

(57) ABSTRACT

A metallized oriented film combination having a substrate with a medium density polyethylene skin layer and a metal layer deposited on the medium density polyethylene skin layer and methods to produce the film are disclosed.

### BACKGROUND OF THE INVENTION

I. Field of the Invention

The present invention relates generally to the field of multi-layer films and more particularly to a metallized film having a polypropylene substrate and a medium density polyethylene layer.

II. Description of the Related Art

Films having a plastic layer and a metal layer have been developed to provide an alternative to metallic foil films, plastic films and other types of films. Since films are typically required to be flexible, it is desirable to have a strong fracture resistance metal-plastic bond.

A number of approaches have been taken to achieve these types of strong metal-plastic bonds. For example, one such approach is disclosed in U.S. Pat. No. 5,194,318, in which a metallized oriented film combination having a propylene homopolymers or copolymer substrate with a high density polyethylene skin layer having a density of 0.96 or greater was disclosed as having superior metal adhesion. However, the use of high density polyethylene can be limiting factor in achieving superior high quality metal-plastic bonds due to process considerations.

A number of other approaches have been disclosed such as U.S. Pat. No. 4,345,005 that uses an ethylene propylene copolymer skin followed by bi-axial orientation and corona treatment. Other approaches include the modification of the surface of the polyolefin film using oxidation processes and/or adhesive with primer coatings.

### SUMMARY OF THE INVENTION

In accordance with the present invention and the contemplated problems which have and continue to exist in this field, the invention features a metallized oriented film combination having a substrate with a medium density polyethylene skin layer and a metal layer deposited on the medium density polyethylene skin layer.

In general, in one aspect, the invention features a multi-layer film combination comprising a propylene substrate having a polyethylene skin layer on at least one of the substrate, the polyethylene skin layer having a thin metal layer deposed thereon.

In one implementation, the substrate is propylene homopolymer.

In another implementation, the substrate is a propylene copolymer.

In another implementation, the substrate is a propylene co-monomer.

In another implementation, the substrate is propylene terpolymer.

In another implementation, the polyethylene of the polyethylene skin layer is medium density.

In another implementation, the density of the polyethylene in the polyethylene skin layer is about 0.92 to 0.956.

In yet another implementation, the film has a total film thickness of about 12.5 to about 45 microns.

In still another implementation, the polyethylene skin layer has a thickness from about 1 micron or less.

In another implementation, the thin metal layer provides a minimum optical density of 2.0.

In another implementation, the substrate is about 84% to 90% of the total film thickness.

In another implementation, the propylene skin layer is about 0.5 to 1 micron.

One advantage of the invention is that it provides a multi-layer polymeric film with a strong metal-polymer bond with a fracture resistant surface using polymers that include medium density polyethylenes as the skin layer.

One advantage of the invention is that the medium density polyethylene layer provides excellent metal adhesion.

Another advantage is that the need for high density polyethylene is eliminated.

Another advantage is that the metallized film has excellent metal fracture resistance.

Another advantage is that the film has low water vapor and oxygen transmission rates compared to non-metallized polypropylene film.

Another advantage is that good metal bonding is provided with ease of manufacturing and low cost.

Other objects, advantages and capabilities of the invention will become apparent from the following description taken in conjunction with the accompanying drawings showing the preferred embodiment of the invention.

### DETAILED DESCRIPTION OF THE INVENTION

Referring to the drawings wherein like reference numerals designate corresponding parts throughout the several figures, reference is made first to the structure which is typically a metallized oriented film combination.

### Film Structure

This film typically includes a propylene substrate. The substrate typically a homopolymer layer or copolymer polypropylene composition. The film typically further includes a medium density polyethylene skin layer on at least one side of the substrate. The polyethylene layer includes a thin metal layer deposed on the polyethylene layer.

The propylene homopolymers used in several of the embodiments described herein include commercially available film grade homopolymers manufactured substantially of propylene with isotactic content ranging from 80-100% and typically from 95-96%. The melt flow rate ranges from about 1 to about 10 grams/10 minutes and typically a melt index range from about 1.5-3 grams/10 minutes. Typically, the melt index aids in the processing during the bi-axial stretching operation.

The propylene terpolymers used in the embodiments can include those with ethylene content from 1 to 8% and butene-1 from 3-20%. It is understood that several different insertions other than butene, such as alpha co-monomers and higher homologs like octanes can be included.

The medium density polyethylene includes polyethylene having a density of about 0.92-0.956. The medium density polyethylene can be composed of a single medium density polyethylene or a medium density polyethylene containing a minor percentage of hexane or octane component.

In a typical embodiment, the total film thickness is from about 12.5 to 45 microns and the polyethylene layer is typically from about 1 micron or less. The metal layer is deposited to a thickness that provides a minimum optical density of 2.0.

The terpolymer skin provides heat seal capability to the film when used in such applications. This terpolymer skin is useful for applications such as desired sealing properties.

### Film Preparation

A method of producing a base film, typically comprised of a homopolymer or copolymer, for superior adhesion to a metallized layer is now discussed. The base is typically produced by co-extruding the medium density polyethylene layer onto the selected base and subsequently orienting the structure in both the machine and transverse directions. The medium density surface is then treated by corona discharge treatment or by flame treatment to promote adhesion of the metal layer.

In a typical implementation, the polymers are brought to a molten state and co-extruded from a conventional extruder through a flat sheet die, the melt streams being combined in an adapter prior to being extruded from the die. After leaving the die, the multi-layer film structure is chilled and the quenched sheet is then reheated and oriented.

The film is typically biaxially oriented in the machine direction a number of times (typically about five times) and in the transverse direction a number of times (typically about nine times). After orientation, the edges of the film are trimmed and the film is wound into a roll.

In general, the total film thickness can be illustrated by layers ABC where layer A is the outer layer, layer B is the core layer and the functional medium density layer is typically employed in the C layer. The film is typically from about 12.5 to 45 microns.

The thickness relationship of the layers is generally important. In particular, the C skin layer is provided as the medium density polyethylene skin layer of about 0.5 to 1 micron when the total film is, for example, about 15 microns.

The core layer, the B layer, can vary in many constructions. In one embodiment, the B layer is typically 97% in 45 micron constructions. Typically, the B layer ranges from about 84 to 97% relative to the total thickness of the film.

Typically, the base film including the medium density polyethylene layer, is then metallized using known methods such as electroplating, sputtering, vacuum metallizing and vacuum deposition. Typical metals include but are not limited to aluminum, copper, silver and chromium. In addition, in chamber pretreatment plasma and surfaces in modified atmosphere are also considered.

As an example, a metallized film combination can typically be constructed including a propylene homopolymers substrate of melt index of approximately 2.0 and a medium density polyethylene skin layer as described below, the polyethylene having a thin metal layer deposited thereon. The metallized samples are extrusion laminated to another polypropylene film using low density polyethylene and the subsequent lamination tested for metal adhesion to the low density polyethylene extrudate.

The results are:

| | | | | Metal | Al |
|---|---|---|---|---|---|
| Example | A micron | 608F LDPE | BOND | Transfer | Fracture |
| 1 | 1.0 (NOVA) | NOVACORE | 94 | No | None |
| 2 | 0.7 (NOVA) | NOVACORE | 99 | No | None |
| 3 | 0.5 (NOVA) | NOVACORE | 104 | No | None |
| 4 | 0.5 (ATOFina) | NOVACORE | 105 | No | None |
| 5. | CONTROL | NOVACORE | 85 | Yes | Medium |

Typically, all thicknesses (o.5, 0.7, 1.0) of the medium density polyethylene (NOVA and ATO) have superior polyethylene to metal bond strengths as compared to the CONTROL. All samples showed no metal fracture or metal delamination for all the samples except for the CONTROL. The line speed during the tests is 220 RPM and the amount of low density polyethylene used is typically 10#/ream.

Various film constructions are typically produced that include ABC type structures where the total film thicknesses are held constant at 17.8 microns. The C layer represents a standard homopolymer with slip additives and is kept constant at one micron. Medium density polyethylene is co-extruded onto a polypropylene homopolymer B layer to form the A layer. The A layer is varied in thickness from 1 to 3 microns. The medium density surface of the film is treated to an off-line level of 44 dynes/cm.

Films with 1 to 3 microns of medium density polyethylene on the treated surface are vacuum metallized with aluminum, using conventional techniques to an optical density of 2.5. To assess the degree of adhesion between the aluminum and the medium density polyethylene A layer for the films a 3M Company 610 tape test is performed on each film.

The metallized films are subsequently extrusion laminated to an oriented polypropylene slip using a low density polyethylene (e.g. 10 lb/ream) at a melt temperature of 620 F. The metallized coextruded films are measured for lamination bond strength to low density polyethylene and percent metal transfer from the metallized surface. Metal fracture is also inspected for each lamination with the light scope at 25× microscopy magnification microscopy magnification. Results of the evaluation are include in the Table above. Also shown for comparison purposes are the results typical of metallization directly on a treated polypropylene homopolymer layer.

Therefore, the foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A multi-layer film combination comprising a propylene substrate having a polyethylene skin layer on at least one side of the substrate, the polyethylene skin layer having a thin metal layer deposited thereon.

2. The combination as claimed in claim 1, wherein the substrate is propylene homopolymer.

3. The combination as claimed in claim 1, wherein the substrate is propylene copolymer.

4. The combination as claimed in claim 1, wherein the substrate is a propylene terpolymer.

5. The combination as claimed in claim 1, wherein the polyethylene of the polyethylene skin layer is medium density.

6. The combination as claimed in claim 5, wherein the density of the polyethylene in the polyethylene skin layer is about 0.92 to 0.956.

7. The combination as claimed in claim 1, wherein the film has a total film thickness of about 12.5 to about 45 microns.

8. The combination as claimed in claim 1, wherein the polyethylene skin layer has a thickness from about 1 micron or less.

9. The combination as claimed in claim 1, wherein the thin metal layer provides a minimum optical density of 2.0.

10. The combination as claimed in claim 1, wherein the substrate is about 84-90% of the total film thickness.

11. The combination as claimed in claim 10, wherein the polyethylene skin layer is about 0.5 to 1 micron.
